(19) United States
(12) Patent Application Publication
(10) Pub. No.: US 2025/0334758 A1
(43) Pub. Date: Oct. 30, 2025

(54) ELECTRO-OPTIC BRIDGE CHIPS FOR CHIP-TO-CHIP COMMUNICATION

(71) Applicant: GlobalFoundries U.S. Inc., Malta, NY (US)

(72) Inventors: Farid Barakat, Clifton Park, NY (US); Arpan Dasgupta, Beacon, NY (US); Zahidur Chowdhury, New Windsor, NY (US); Koushik Ramachandran, Wappingers Falls, NY (US); Norman Robson, Fishkill, NY (US)

(21) Appl. No.: 18/648,715

(22) Filed: Apr. 29, 2024

(51) Int. Cl. G02B 6/42

(52) U.S. Cl. CPC G02B 6/4226; G02B 6/4204; G02B 6/4227; G02B 6/428

(57) ABSTRACT

Structures including a photonic chip and methods of forming and using such structures. The structure comprises a first substrate, a photonic chip attached to a first portion of the first substrate, and an optical connector including a second substrate and a plurality of piezoelectric actuators disposed between a second portion of the first substrate and the second substrate. The second substrate includes a plurality of waveguide cores disposed adjacent to an interface for light transfer between the waveguide cores and the photonic chip, and the piezoelectric actuators are configured to change an alignment of the waveguide cores at the interface relative to the photonic chip.

### BACKGROUND

The present disclosure relates generally to semiconductor devices and integrated circuit fabrication and, more specifically, to structures including a photonic chip and methods of forming and using such structures.

Photonic chips are used in many applications and systems including, but not limited to, data communication systems and data computation systems. A photonic chip includes a photonic integrated circuit comprised of photonic devices, such as modulators, polarizers, and optical couplers, that are used to manipulate light received from a light source, such as a laser or an optical fiber.

An edge coupler, also known as a spot-size converter, is a type of photonic device that is commonly used for coupling light of a given mode from the light source to the photonic integrated circuit. The edge coupler may include a section of a waveguide core that defines an inverse taper having a tip. The narrow end of the inverse taper at the tip is positioned adjacent to the light source, and the wide end of the inverse taper is connected to another section of the waveguide core that routes the light to the photonic integrated circuit.

The gradual variation in the cross-sectional area of the inverse taper supports mode transformation and mode size variation associated with mode conversion when light is transferred from the light source to the edge coupler. The tip of the inverse taper is unable to fully confine the incident mode received from the light source because the cross-sectional area of the tip is considerably smaller than the mode size. Consequently, a significant percentage of the electromagnetic field of the incident mode is distributed about the tip of the inverse taper. As its width dimension increases, the inverse taper can support the entire incident mode and confine the electromagnetic field.

The alignment between the light source and the edge coupler may not remain static over time. Instead, age, a temperature change, or a change in the refractive index of the edge coupler may cause misalignment between the light source and the edge coupler. As a result, the insertion loss may increase over time without any mechanism to correct the misalignment.

Improved structures including a photonic chip and methods of forming such structures are needed.

### SUMMARY

In an embodiment, a structure comprises a first substrate, a photonic chip attached to a first portion of the first substrate, and an optical connector including a second substrate and a plurality of piezoelectric actuators disposed between a second portion of the first substrate and the second substrate. The second substrate includes a plurality of waveguide cores disposed adjacent to an interface for light transfer between the waveguide cores and the photonic chip, and the piezoelectric actuators are configured to change an alignment of the waveguide cores at the interface relative to the photonic chip.

In an embodiment, a structure for use with a photonic chip is provided. The structure comprises an optical connector including a plurality of waveguide cores and a plurality of piezoelectric actuators. The optical connector is disposed adjacent to the photonic chip with the plurality of waveguide cores at an interface for light transfer between the optical connector and the photonic chip. The piezoelectric actuators are configured to change an alignment of the plurality of waveguide cores at the interface relative to the photonic chip.

In an embodiment, a method comprises detecting an increase in insertion loss at an interface for light transfer between an optical connector and a photonic chip, and adjusting a plurality of piezoelectric actuators to adjust a position of the optical connector and reduce the insertion loss at the interface.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals are used to indicate like features in the various views.

FIG. 1 is a top view of a structure in accordance with embodiments of the invention.

FIG. 2 is a side view of the structure of FIG. 1.

FIG. 3 is a top view of a structure in accordance with alternative embodiments of the invention.

### DETAILED DESCRIPTION

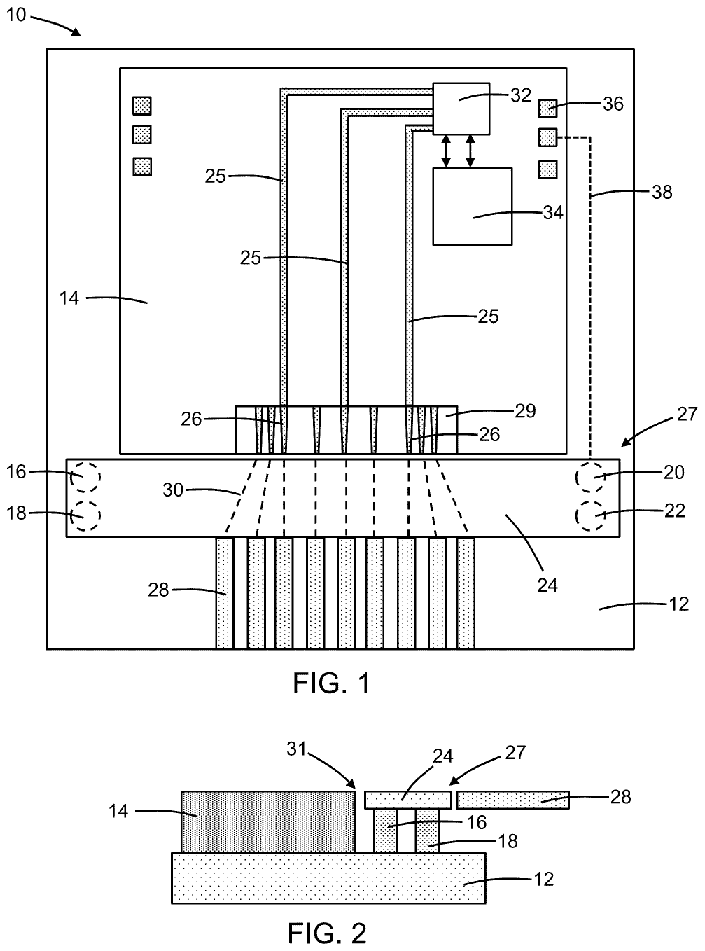

With reference to FIG. 1 and in accordance with embodiments of the invention, a structure 10 includes a substrate 12, a photonic chip 14 attached to a confronting portion of the substrate 12, piezoelectric actuators 16, 18, 20, 22, and a substrate 24 coupled by the piezoelectric actuators 16, 18, 20, 22 to a confronting portion of the substrate 12. The piezoelectric actuators 16, 18, 20, 22 are disposed between the substrate 24 and the confronting portion of the substrate 12. Each of the piezoelectric actuators 16, 18, 20, 22 may include a portion attached to the substrate 24 and a portion attached to the confronting portion of the substrate 12. The optical fibers 28 may be disposed in an optical fiber array in which the individual optical fibers 28 have fixed or static positions relative to the substrate 24.

The substrate 12 may include an epoxy-glass cloth core and alternating layers of metal and electrical insulator that are laminated to the epoxy-glass cloth core. In an alternative embodiment, the substrate 12 may include a ceramic core and alternating layers of metal and electrical insulator that are laminated to the ceramic core. A build-up of the alternating layers of the substrate 12 may be disposed adjacent to the photonic chip 14 and adjacent to the substrate 24.

The photonic chip 14 includes photonic components, such as modulators, polarizers, and optical couplers, arranged in a functional photonic integrated circuit that is configured to manipulate light received from one or more light sources, such as optical fibers or lasers. In particular, the photonic chip 14 includes waveguide cores 25, and each waveguide core 25 may include an edge coupler 26. For example, each edge coupler 26 may be configured in the shape of an inverse taper that provides mode transformation. The photonic chip 14 may be fabricated using a silicon-on-insulator substrate.

The waveguide cores 25 may be comprised of a material having a refractive index that is greater than the refractive index of silicon dioxide. In an embodiment, the waveguide cores 25 may be comprised of a dielectric material, such as silicon nitride, silicon oxynitride, or aluminum nitride. In an alternative embodiment, the waveguide cores 25 may be comprised of a semiconductor material, such as single-crystal silicon, amorphous silicon, or polysilicon. In an embodiment, the waveguide cores 25 may be formed by patterning a layer of their constituent material with lithography and etching processes.

The edge couplers 26 may be surrounded by, and embedded in, a dielectric layer 29 that provide low-index cladding. The dielectric layer 29 may be comprised of a dielectric material, such as silicon dioxide, having a refractive index that is less than the refractive index of the material constituting the edge couplers 26.

The substrate 24 may be formed from a material that is selected to provide mechanical support for multiple waveguide cores 30. In an embodiment, the substrate 24 may be comprised of glass. In an embodiment, the waveguide cores 30 may be inscribed in the material of the substrate 24 by laser writing to locally increase the refractive index of portions of the material of the substrate 24. The waveguide cores 30 are surrounded by, and embedded, in the material of the substrate 24 that supplies low-index cladding.

The waveguide cores 30 are configured to transfer light between the optical fibers 28 and the edge couplers 26 of the photonic chip 14. Each of the waveguide cores 30, which have fixed or static positions relative to the substrate 24, includes a portion (e.g., an end) that is disposed at an interface 31 for light transfer between the optical connector 27 and the photonic chip 14. An opposite portion of each waveguide core 30, such as an opposite end of each waveguide core 30, is disposed adjacent to one of the optical fibers 28. The waveguide cores 30 may cooperate with the edge couplers 26 to transfer light at the interface 31 between the waveguide cores 30 and the edge couplers 26. The piezoelectric actuators 16, 18, 20, 22, the substrate 24, and the waveguide cores 30 provide an optical connector 27 that is disposed adjacent to the interface 31 and the piezoelectric actuators 16, 18, 20, 22 can be used to adjust the position of the substrate 24 and waveguide cores 30 at the interface 31 and relative to the edge couplers 26. In contrast to the optical connector 27 and its waveguide cores 30, the edge couplers 26 have fixed or static positions at the interface 31.

The photonic chip 14 may include a photodetector 32 that is coupled by the waveguide cores 25, the edge couplers 26 of the waveguide cores 25, and the waveguide cores 30 to particular optical fibers 28 in the optical fiber array. The photodetector 32 may be configured to convert light into an electrical signal. In that regard, the photodetector 32 may include a semiconductor layer comprised of a light-absorbing material that can generate charge carriers from photons of absorbed light by photoelectric conversion. The material of the semiconductor layer of the photodetector 32 may be selected to optimize absorption of light having a specific wavelength. In an embodiment, the semiconductor layer of the photodetector 32 may be comprised of an intrinsic semiconductor material. In an embodiment, the semiconductor layer of the photodetector 32 may be comprised of intrinsic germanium. In an embodiment, the semiconductor layer of the photodetector 32 may be comprised of intrinsic silicon-germanium. In an alternative embodiment, the semiconductor layer of the photodetector 32 may be comprised of a different type of semiconductor material, such as a III-V compound semiconductor material or intrinsic silicon.

The waveguide cores 25, which are connected at one end to the photodetector 32 and at an opposite end to edge couplers 26, are configured to guide light received by the edge couplers 26 to the photodetector 32. As a result, light originating from some of the optical fibers 28 can be used for diagnostic purposes, as subsequently discussed. Additional waveguide cores similar to the waveguide cores 25 include edge couplers 26 that transfer light at the interface 31 between the optical connector 27 and the photonic integrated circuit of the photonic chip 14. The waveguide cores 30 are spaced from the edge couplers 26 at the interface 31 by a gap that may be filled by an index-matching material. The existence of the gap at the interface 31 enables the active alignment of the waveguide cores 30 relative to the edge couplers 26 at the light-transfer interface 31. The optical connector 27 also permits the photonic chip 14 to be fabricated without forming grooves to align and seat the optical fibers 28 adjacent to the edge couplers 26 in static or fixed positions.

The piezoelectric actuators 16, 18, 20, 22 are configured to move the substrate 24 relative to the interface 31 over a travel range in one or more directions of motion. The positions of the waveguide cores 30, which move with the movement of the substrate 24, are adjusted by the movement of the substrate 24 within the travel range. In particular, the positions of the waveguide cores 30 of the substrate 24 may be adjusted relative to the positions of the edge couplers 26 by using the piezoelectric actuators 16, 18, 20, 22 to move the optical connector 27. The positions of the optical fibers 28 may be fixed relative to the waveguide cores 30 such that that the optical fibers 28 move in conjunction with the movement of the substrate 24.

The substrate 24 of the optical connector 27 may be physically moved by the piezoelectric actuators 16, 18, 20, 22 relative to the plane of the substrate 12 based on feedback received from the photodetector 32. For example, the substrate 24 may be physically moved by the piezoelectric actuators 16, 18, 20, 22 relative to the plane of the substrate 12 to either increase the separation or decrease the separation based on feedback received from the photodetector 32. In an embodiment, the substrate 24 may include outer corners and the piezoelectric actuators 16, 18, 20, 22 may be disposed adjacent to different outer corners of the substrate 24. In an embodiment, the piezoelectric actuators 16, 18, 20, 22 may be symmetrically disposed adjacent to the different corners of the substrate 24. Placement of the piezoelectric actuators 16, 18, 20, 22 at spaced-apart locations between the substrate 24 and the confronting portion of the substrate may enable the movement of the substrate 24 relative to the substrate 12. In an embodiment, the piezoelectric actuators 16, 18, 20, 22 may orient the plane of the substrate 24 parallel to the plane of the substrate 12. In an embodiment, the piezoelectric actuators 16, 18, 20, 22 may orient the plane of the substrate 24 to be inclined (i.e., not parallel) to the plane of the substrate 12. In an embodiment, the piezoelectric actuators 16, 18, 20, 22 may be configured to tilt the plane of the substrate 24 relative to the plane of the substrate 12. In an alternative embodiment, the piezoelectric actuators 16, 18, 20, 22 may be configured to move the substrate 24 in multiple directions relative to the plane of the substrate 12. The waveguide cores 30, which are embedded at fixed positions inside the substrate 24, experience the same movements as the substrate 24.

The piezoelectric actuators 16, 18, 20, 22 may be transducers that include a piezoelectric material configured to convert electrical energy directly into motion (i.e., mechanical displacement) based on the inverse piezoelectric effect. An electric field applied in a direction of polarization of the piezoelectric material may cause an expansion of the piezoelectric material in the same direction, while a voltage applied in the opposite direction of polarization may cause a contraction of the piezoelectric material in that same direction. In an embodiment, the motions of the piezoelectric actuators 16, 18, 20, 22 may be constituted by axial displacements such that the substrate 24 is physically displaced by linear motion vertically relative to the substrate 12 in response to electrical inputs. For example, the movements of the piezoelectric actuators 16, 18, 20, 22 may axially move the substrate 24 vertically relative to the substrate 12 in response to electrical inputs. In an embodiment, the piezoelectric actuators 16, 18, 20, 22 may be embodied by a unitary structure that includes a body comprised of a piezoelectric material, such as lead zirconate titanate or another material that exhibits the inverse piezoelectric effect, that is disposed between a pair of electrodes that receive the electrical input. In an embodiment, the piezoelectric actuators 16, 18, 20, 22 may be embodied by a stack of piezoelectric layers and electrodes that are interleaved with the piezoelectric layers and receive the electrical input.

A controller 34 may be coupled in communication with the photodetector 32 and with the piezoelectric actuators 16, 18, 20, 22. In an embodiment, the controller 34 may be integrated on the photonic chip 14. The photonic chip 14 may include bond pads 36 that are coupled by communication paths 38 represented by metal traces in the metal layers of the substrate 12 to the piezoelectric actuators 16, 18, 20, 22.

The controller 34 may include a processor, a memory, and an input/output interface that provides communication with the photodetector 32 and with the piezoelectric actuators 16, 18, 20, 22. The processor of the controller 34 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored as data in the memory. The memory of the controller 34 may include one or more memory devices including, but not limited to, read-only memory, random access memory, volatile memory, non-volatile memory, static random access memory, dynamic random access memory, flash memory, cache memory, or any other device capable of data storage.

The controller 34 is configured to receive an electrical signal from the photodetector 32 and, in response to the electrical signal received from the photodetector 32, to determine a light intensity corresponding to the electrical signal. The waveguide cores 25 provide multiple distinct channels that can supply feedback to the controller 34. The controller 34 may be equipped to execute an algorithm that determines movements of the piezoelectric actuators 16, 18, 20, 22, based on the feedback, that are calculated to move the substrate 24 of the optical connector 27 for altering the alignment of the waveguide cores 30 relative to the edge couplers 26 and the associated light intensity. The controller 34 outputs control signals over the input/output interface that are communicated to the electrodes of the piezoelectric actuators 16, 18, 20, 22 as motion commands to dynamically displace the waveguide cores 30 of the optical connector 27 to a desired position. The controller 34 may optimize the light intensity received by one or more of the edge couplers 26 connected to the photodetector 32. The waveguide cores 30 of the optical connector 27 and the edge couplers 26 that are coupled to the photonic integrated circuit of the photonic chip 14, which do not supply feedback to the controller 34, may also be aligned by the feedback-driven movements of the optical connector 27 such that the light intensity supplied to the photonic integrated circuit of the photonic chip 14 is optimized.

In use, light from the edge couplers 26 may be routed by the waveguide cores 25 over the different channels to the photodetector 32, which outputs an electrical signal to the controller 34 that is proportional to the detected light intensity. The detected light intensity may be proportional to the insertion loss at the interface 31 between the waveguide cores 30 of the optical connector 27 and the photonic chip 14. A reduction in the light intensity may indicate to the controller 34 that the insertion loss at the interface 31 between the waveguide cores 30 of the optical connector 27 and the photonic chip 14 has increased. The controller 34 may compare the light intensity received from the photodetector 32 to an acceptable threshold value for the light intensity to determine an unacceptable insertion loss and/or may perform a trend analysis to determine an unacceptable insertion loss. To reduce the insertion loss, the controller 34 may send control signals to the piezoelectric actuators 16, 18, 20, 22 as motion commands to dynamically adjust the position of the substrate 24 and, therefore, the waveguide cores 30 in an attempt to reduce the insertion loss by correcting any misalignment. The electrical signal from the photodetector 32 may provide continuous feedback to the controller 34 during the dynamic adjustment process.

The piezoelectric actuators 16, 18, 20, 22 may be used to adjust the alignment between the waveguide cores 30 and the edge couplers 26 at the interface 31 between the optical connector 27 and the photonic chip 14 to maximize the intensity of the light transferred between the waveguide cores 30 and the edge couplers 26 and, thereby, reduce the insertion loss. The dynamic repositioning of the waveguide cores 30 may be used to compensate for increases in insertion loss at the interface 31 arising from dynamic factors, such as aging, a temperature change caused by the environment of the photonic chip 14, or a change in the refractive index of the edge couplers 26.

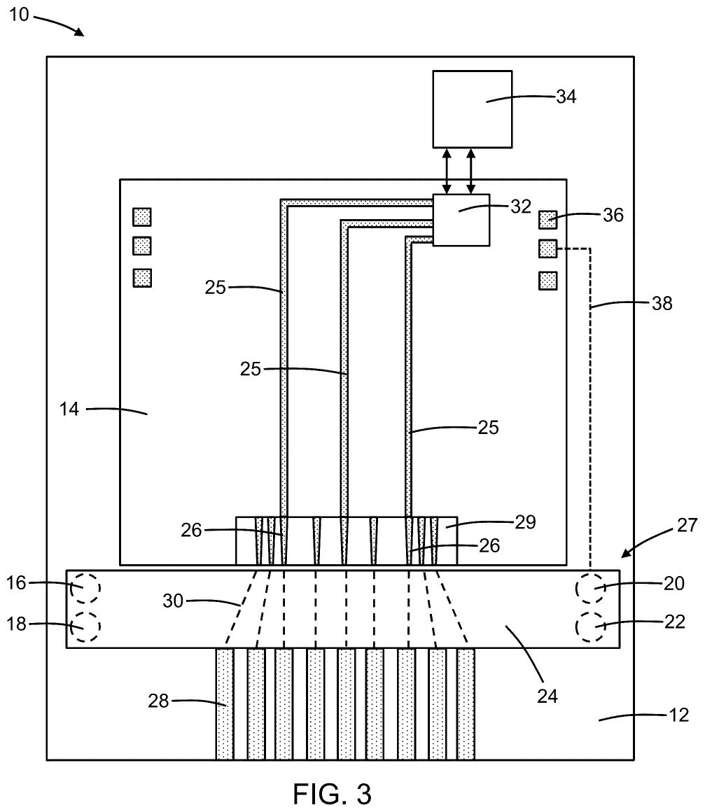

With reference to FIG. 3 and in accordance with alternative embodiments, the controller 34 may be disposed as a separate chip on a portion of the substrate 12 instead of being disposed on the photonic chip 14. Space on the photonic chip 14 may be conserved by relocating the controller 34. The controller 34 is coupled by one or more electrical communication paths of the photonic chip 14 and the substrate 12 to the photodetector 32, and the controller 34 is coupled by electrical communication paths of the substrate 12 to the piezoelectric actuators 16, 18, 20, 22.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for use with a photonic chip, the structure comprising:
an optical connector including a plurality of waveguide cores and a plurality of piezoelectric actuators, the optical connector disposed adjacent to the photonic chip with the plurality of waveguide cores at an interface for light transfer between the optical connector and the photonic chip, and the plurality of piezoelectric actuators configured to change an alignment of the plurality of waveguide cores at the interface relative to the photonic chip.

2. The structure of claim 1 wherein the optical connector includes a substrate, the plurality of waveguide cores have static positions on the substrate, and the plurality of piezoelectric actuators are attached to the substrate.

3. The structure of claim 2 wherein the plurality of piezoelectric actuators are configured to position the substrate relative to the photonic chip in order to align the plurality of waveguide cores at the interface relative to the photonic chip.

4. The structure of claim 2 wherein the substrate includes a plurality of outer corners, and each of the plurality of piezoelectric actuators is attached to the substrate adjacent to one of the outer corners.

5. The structure of claim 2 wherein the substrate comprises glass, and the plurality of waveguide cores are embedded in the glass of the substrate.

6. A structure comprising:
a first substrate having a first portion and a second portion;
a photonic chip attached to the first portion of the first substrate; and
an optical connector including a second substrate and a plurality of piezoelectric actuators disposed between the second portion of the first substrate and the second substrate, the second substrate including a first plurality of waveguide cores disposed adjacent to an interface for light transfer between the first plurality of waveguide cores and the photonic chip, and the plurality of piezoelectric actuators configured to change an alignment of the first plurality of waveguide cores at the interface relative to the photonic chip.

7. The structure of claim 6 wherein the photonic chip includes a plurality of edge couplers at the interface, and the first plurality of waveguide cores are configured to be aligned by the plurality of piezoelectric actuators with the plurality of edge couplers at the interface.

8. The structure of claim 7 wherein the photonic chip includes a photodetector and a second plurality of waveguide cores that connect the plurality of edge couplers to the photodetector.

9. The structure of claim 8 further comprising:
a controller coupled in communication with the photodetector and with the plurality of piezoelectric actuators.

10. The structure of claim 9 wherein the controller is configured to operate the plurality of piezoelectric actuators in response to feedback from the photodetector in order to align the first plurality of waveguide cores with the plurality of edge couplers at the interface.

11. The structure of claim 10 wherein the controller is configured to cause the plurality of piezoelectric actuators to move the second substrate to align the first plurality of waveguide cores with the plurality of edge couplers.

12. The structure of claim 11 wherein the controller is configured to receive the feedback from the photodetector in order to reduce insertion loss for light transferred from the first plurality of waveguide cores to the plurality of edge couplers.

13. The structure of claim 9 wherein the controller is disposed on the photonic chip.

14. The structure of claim 9 wherein the controller is disposed on the first substrate.

15. The structure of claim 6 wherein the first substrate comprises glass, and the first plurality of waveguide cores are embedded in the glass of the first substrate.

16. The structure of claim 15 wherein the second substrate comprises a printed circuit board.

17. The structure of claim 6 wherein the first plurality of waveguide cores have static positions on the second substrate, the plurality of piezoelectric actuators are attached to the first substrate, and the plurality of piezoelectric actuators are attached to the second substrate.

18. The structure of claim 17 wherein the plurality of piezoelectric actuators are configured to position the second substrate relative to the photonic chip in order to change the alignment of the first plurality of waveguide cores at the interface relative to the photonic chip.

19. The structure of claim 6 wherein each of the plurality of piezoelectric actuators includes a first portion attached to the first substrate and a second portion attached to the second substrate.

20. A method comprising:
detecting an increase in insertion loss at an interface for light transfer between an optical connector and a photonic chip; and
adjusting a plurality of piezoelectric actuators to adjust a position of the optical connector and reduce the insertion loss at the interface.
